(19) United States
(12) Patent Application Publication
(10) Pub. No.: US 2022/0176263 A1
(43) Pub. Date: Jun. 9, 2022

(54) MODEL PART

(71) Applicant: BANDAI CO., LTD., Tokyo (JP)

(72) Inventors: Hirofumi Kishiyama, Tokyo (JP); Toshiyuki Wakita, Tokyo (JP)

(73) Assignee: BANDAI CO., LTD., Tokyo (JP)

(21) Appl. No.: 17/425,703

(22) PCT Filed: Dec. 27, 2019
(86) PCT No.: PCT/JP2019/051467

§ 371 Date: Jul. 23, 2021

(30) Foreign Application Priority Data
Feb. 5, 2019 (JP) 2019-019034

(51) Int. Cl. A63H 33/04

(52) U.S. Cl. CPC A63H 33/04

(57) ABSTRACT

Provided is a model part including: a plurality of parts that constitute a model; a runner connected to the plurality of parts; and a display section provided on a part of the runner and configured to display identification information associated with at least one of the plurality of parts, wherein the display section includes a base plate portion and a shape structure indicating the identification information and protruding from the base plate portion, and a height of the shape structure with respect to the base plate portion has a size of at least 8% of a length of the shape structure indicating the identification information in a vertical direction of the base plate portion.

### CROSS REFERENCE TO RELATED APPLICATIONS

This application is a National Stage Application, filed under 35 U.S.C. § 371, of International Application No. PCT/JP2019/051467, filed Dec. 27, 2019, which claims priority to Japanese Application No. 2019-019034, filed Feb. 5, 2019; the contents of which are hereby incorporated by reference in their entirety.

### BACKGROUND

### Technical Field

The present invention relates to a model part.

### Description of Related Art

In order to individually identify a plurality of model parts connected to a runner, identification numbers are allocated in association with respective model parts. Japanese Patent Application Publication No. 2009-107275A discloses the invention of a model kit provided with numerals on display sections for allocating the identification numbers.

Japanese Utility Model Registration No. 3154497 discloses the invention of a model kit provided with a pattern reminiscent of a silhouette of a character of model parts together with numbers on similar display sections.

### SUMMARY

However, number notation in the display sections for the identification numbers such as those disclosed in the related art described above requires to have a large character size and display sections as possible in order to ensure visibility of the characters and the patterns. On the other hand, the display sections with an increased size may impede the removal of the model parts from the runner and increasing the amount of molding material, which in turn increases the manufacturing cost. Consequently, a reduction in the size of parts that are not related to the model parts themselves, such as display sections, and thus a reduction in manufacturing cost is required.

In one embodiment, the present invention provides a technique for enabling the achievement of a display section with improved visibility.

In order to solve the above-described problem, the present invention in one embodiment provides a model part including: a plurality of parts that constitute a model; a runner connected to the plurality of parts; and a display section provided on a part of the runner and configured to display identification information associated with at least one of the plurality of parts, wherein the display section includes a base plate portion and a shape structure indicating the identification information and protruding from the base plate portion, and a height of the shape structure with respect to the base plate portion has a size of at least 8% of a length of the shape structure indicating the identification information in a vertical direction of the base plate portion.

According to an embodiment of the present invention, a display section with improved visibility is provided.

### BRIEF DESCRIPTION OF DRAWINGS

FIG. 1 is a drawing illustrating an example of a model part corresponding to an embodiment of the invention.

FIG. 2 is a drawing for explaining a structure of a display section to be disposed in the model parts corresponding to the embodiment of the invention.

### DETAILED DESCRIPTION

Referring now to drawings, exemplary embodiments of the invention will be described below. In each drawing, the same reference sign indicates the same element. In each drawing, up, down, left, and right directions of the paper surface are used for the description in a text as the up, down, left, and right directions of a model piece (or parts) in the present embodiment.

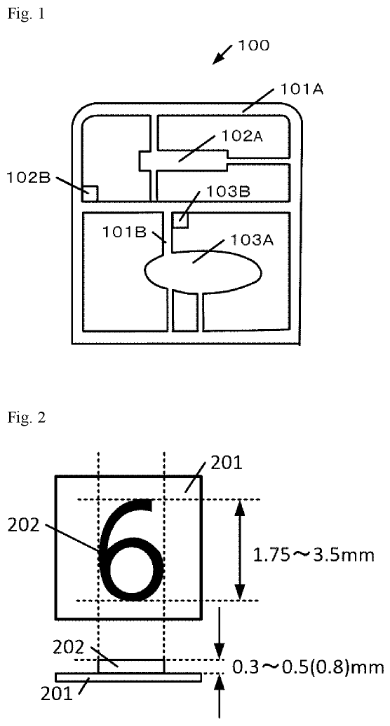

First, the structure of the model part corresponding to the invention is illustrated in FIG. 1. In FIG. 1, a model part 100 includes a main runner 101A, and parts 102A and 103A connected to the main runner 101A. The parts 102A and 103A are parts for constituting a predetermined model and are connected to the main runner 101A via a secondary runner 101B.

Display sections 102B and 103B are display regions provided in association with the parts 102A and 103A for displaying identification information for identifying the corresponding parts. The display section 102B is disposed at a corner, that is, an intersection with the main runner 101A, and the display section 103B is disposed at a corner, that is, an intersection between the main runner 101A and a secondary runner 101B. In this manner, each of the display sections may be disposed at the corner where the runner intersects or at any position on the runner other than the corner.

The size of each display section may be any size that is enough to display numerals of the identification information for identifying the corresponding parts. Referring now to FIG. 2, a specific configuration of the display section will be described.

FIG. 2 is a drawing of an example of the configuration of the display section, illustrating a mode of a display of the identification information in the display section. In FIG. 2, the numeral “6” 202 is displayed on the base plate portion 201, but a type of identification information is not limited thereto. The numeral is not limited to a single digit and may be displayed in multiple digits. Furthermore, alphabets, hiragana, katakana, kanji, symbols, graphical patterns, and the like may be displayed. The identification information in the display section may be displayed in any font. For example, IWATA UD Gothic may be used. The identification information to be displayed in the display sections need only to be contents relating to the parts connected to the runner and includes information on the entire model after the assembly of the plurality of parts, information on each portion of the model, material, company name, and the like.

The size, for example, the length in the vertical direction of the identification information may be ranged from 1.75 mm to 3.5 mm. The width in a transverse direction depends on the type of character. At this time, the shape structure (the numeral “6” in FIG. 2) indicating the identification information is formed on the base plate portion 201 so as to protrude therefrom. The height of the shape structure indicating the identification information formed on the base plate portion 201 with respect to the base plate portion 201 (the thickness of the shape structure) may be ranged from 0.3 mm to 0.5 mm, or from 0.3 mm to 0.8 mm. Accordingly, the ratio of the height of the shape structure indicating the identification information to the length of the shape structure in the vertical direction of the base plate portion 201 ranges from approximately 8% to approximately 46%.

In the present embodiment, if the height of the shape structure indicating the identification information is larger than 0.8 mm, so-called gas-burning may occur. Therefore, the upper limit is set to 0.8 mm. However, if no gas-burning occurs, the upper limit may be increased within a range where gas burn does not occur. Note that “gas burning” is a phenomenon that occurs at the tips of thin ribs during plastic injection molding and is a phenomenon that makes part of the molded product turn black and carbonize.

By providing the identification information with a certain thickness (height) with respect to the base plate portion, the identification information is formed so as to protrude from the base plate portion so that improved visibility is achieved. Improvement of visibility is hardly impaired even when the size of the identification information or the base plate portion is reduced, which allows for a reduction in size of the display section, and thus for a reduction in material cost.

As described thus far, according to the present embodiment, a model part having highly visible display sections with the identification information for identifying the parts is provided.

1-7. (canceled)

8. A model part comprising:
a plurality of parts;
a runner connected to the plurality of parts; and
a display section provided on a part of the runner and configured to display identification information associated with at least one of the plurality of parts,
wherein the display section comprises a base plate portion comprising a protruding shape structure indicating the identification information and comprising a height from the base plate portion,
wherein the height of the protruding shape structure has a size of at least 8% of a length of the protruding shape structure in a vertical direction of the base plate portion.

9. The model part according to claim 8, wherein the height of the protruding shape structure is included within at least a range from 8% to 46% of the length of the protruding shape structure in the vertical direction of the base plate portion.

10. The model part according to claim 8, wherein the length of the protruding shape structure in the vertical direction of the base plate portion is within a range from 1.75 mm to 3.5 mm.

11. The model part according to claim 8, wherein the height of the protruding shape structure is within a range from 0.3 mm to 0.5 mm.

12. The model part according to claim 8, wherein the height of the protruding shape structure is within a range from 0.3 mm to 0.8 mm.

13. The model part according to claim 8, wherein the height of the protruding shape structure is 0.4 mm.

14. The model part according to claim 8, wherein the display section is a display section for displaying identification information provided in association with each of the plurality of parts, and the identification information is information for identifying the corresponding parts.
